(19) United States
(12) Patent Application Publication
(10) Pub. No.: US 2014/0198482 A1
(43) Pub. Date: Jul. 17, 2014

(54) Apparatus for transmitting light

(71) Applicant: C P Industries Limited, Hong Kong (HK)

(72) Inventor: Lai Chor Yue, Hong Kong (HK)

(73) Assignee: C P Industries Limited, Hong Kong (HK)

(21) Appl. No.: 14/151,807

(22) Filed: Jan. 10, 2014

(30) Foreign Application Priority Data
Jan. 11, 2013 (AU) 2013900093
Jan. 28, 2013 (AU) 2013900255

(51) Int. Cl. F21V 31/00

(52) U.S. Cl. CPC F21V 31/005
USPC 362/96

(57) ABSTRACT

The present invention relates to an apparatus for transmitting light comprising a first portion adapted for receiving the light emitting member; a battery being mounted inside the said apparatus; and a floating means for allowing a portion of the apparatus to be floated above the water level comprising a weight member being mounted to an end portion of the said apparatus adapted for providing downward force to the apparatus and a hollow floating region adapted for providing upward force to the apparatus arranged inside the said apparatus.

### TECHNICAL FIELD

The present invention relates to an apparatus for transmitting light, and in particular, the present invention relates to a waterproof mechanical powered apparatus for transmitting light.

### BACKGROUND OF THE INVENTION

A torch is an apparatus for transmitting light that is frequently used in daily life. The torch is particularly applicable to some lighting demands during outdoor activities or indoor lighting purposes of people due to its small size and convenience in carry. However, the torch of the existing technology merely has a lighting function, which cannot meet more practical demands of people during daily life.

### SUMMARY OF THE INVENTION

The problem to be solved in the present invention is to provide a multi-functional apparatus for transmitting light instead of a torch with only one technical feature of the existing technology. Another problem to be solved in the present invention is to provide a convenient waterproof mechanical powered apparatus for transmitting light adapted to be charged by hand.

The present invention provides an apparatus for transmitting light comprising a first portion adapted for receiving the light emitting member; a battery being mounted inside the said apparatus; and a floating means for allowing a portion of the apparatus to be floated above the water level comprising a weight member being mounted to an end portion of the said apparatus adapted for providing downward force to the apparatus and a hollow floating region adapted for providing upward force to the apparatus arranged inside the said apparatus.

In an embodiment, the said apparatus further comprises a second portion being removably mounted to the said first portion, a third portion being removably mounted to the said second portion and a fourth portion being removably mounted to the said third portion, a battery is mounted inside the said second portion.

In an embodiment, the said hollow floating region comprises a first hollow floating region being arranged between an inner wall and the said light emitting member, a second hollow floating region being formed between an inner wall of the said second portion and an outer wall of the said battery and a third hollow floating region being formed between the opposing inner walls of the said third portion.

In an embodiment, the apparatus further comprises a battery charging means for charging the said battery through rotating motion of the said third portion of the apparatus.

In an embodiment, the battery charging means comprises an extending member which is mounted to an end of the said second portion, the said extending member is adapted for charging the said battery by rotating the said extending member, the said battery charging means further comprises an extending member receiver adapted for receiving the said extending member mounted to an end of the said third portion,

In an embodiment, the said extending member comprises a polygonal cylindrical structure.

In an embodiment, the said weight member is mounted inside the said fourth portion.

In an embodiment, the apparatus further comprises a handle means for mounting the said third portion to the said second portion and preventing the said third portion being removed from the said second portion during the movement of rotating the said third portion.

In an embodiment, the said handle means comprises a handle, a threaded portion of the said second portion and a first thread locking structure being mounted to the said threaded portion, the said first thread locking structure is adapted for mounting an end of a thread line of a threaded portion of an inner wall of the said handle.

In an embodiment, the said handle means further comprises a second thread locking structure mounted on a surface of an end portion of the said second portion, the said second thread locking structure is adapted for mounting the said second thread locking structure to an extension which is mounted on the said threaded portion of the inner wall of the said handle.

In an embodiment, the apparatus further comprises a pressure balancing film mounted on an end of the said second portion facing an end of said third portion, the said pressure balancing film comprises a plurality of holes adapted for allowing air to pass through the said hole only.

In an embodiment, the said third portion is adapted to be rotated about the axis of the said extending member.

In an embodiment, the said third portion is removably mounted to the said fourth portion, an outer side wall of the said fourth portion has a hole forming a bottle opener, the said third portion forms a storage region adapted for receiving at least one article inside the said third portion, the said second portion comprises an external charging member adapted for providing electricity from the said battery to an article.

In an embodiment, the height of the said first locking structure is higher than the height of the said thread portion of the said second portion, the said first locking structure is mounted between at least two thread lines of the said thread portion.

Compared with the prior art, the apparatus for transmitting light provided by the invention is connected with portions having hollow floating regions. The hollow floating regions may generate buoyancy, so that the apparatus for transmitting light cannot sink to the water bottom while falling to the water; therefore, the apparatus for transmitting light is more suitable for outdoor application, for example, outdoor lighting for camping and cross-country. Moreover, there is no need to worry that the apparatus for transmitting light will sink to the water bottom when falling into the water accidentally.

### DESCRIPTION OF DRAWINGS

This and other objects, features and advantages of the present invention will become apparent upon reading of the following detailed descriptions and drawings, in which:

FIG. 1 shows a front view of an embodiment of the present invention;

FIG. 2 shows a sectional view of FIG. 1;

FIG. 3 shows a first exploded view of an embodiment of the present invention;

FIG. 4 shows an exploded view of the third and fourth portions of an embodiment of the present invention;

FIG. 5 shows a perspective sectional view of the first and second portions of an embodiment of the present invention;

FIG. 6 is a perspective sectional view of the third and fourth portions of an embodiment of the present invention;

FIG. 7 shows a second exploded view of an embodiment of the present invention;

FIG. 8 shows a front view showing the threaded portion of the second portion of an embodiment of the present invention;

FIG. 9 shows a sectional view of the handle of an embodiment of the present invention; and

FIG. 10 shows a perspective view of the second portion of an embodiment of the present invention.

Description of parts

| | |
|---|---|
| First portion | 10 |
| Light emitting member | 101 |
| Shell | 102, 202 |
| Light transmitting window | 103 |
| First hollow floating region | 104 |
| Second hollow floating region | 209 |
| Third hollow floating region | 321 |
| Window | 105 |
| Lens | 106 |
| Protective cover | 107 |
| Seal ring | 108, 201, 330 |
| Second portion | 20 |
| Power supply | 203 |
| Transition section | 204 |
| Switch | 205 |
| Sealing member | 206, 210 |
| Battery | 207 |
| Extending member | 208 |
| Discharging interface | 209 |
| Connecting part | 211, 323 |
| Third portion | 30 |
| Handle | 31 |
| Body | 310 |
| First connecting part | 311 |
| Second connecting part | 312 |
| Third portion | 32 |
| Bottom board | 322 |
| Extending member receiver | 324 |
| Bottom cover | 33 |
| Weight member | 331 |
| Commodity shelf | 332 |
| Hole | 333 |
| Board body | 334 |
| Support | 335 |
| First storage region | 336 |
| Second storage region | 337 |
| Third storage region | 338 |
| Whistle | 34 |
| Compass | 35 |
| Knife | 36 |
| Fourth portion | 40 |
| First thread locking structure | 505 |
| Second thread locking structure | 506 |
| Threaded portion of second portion | 501 |
| Threaded portion of inner wall of handle | 502 |
| Extension on threaded portion of inner wall of handle | 503 |
| Pressure balancing film | 601 |
| Hole of pressure balancing film | 611 |
| Bottle opener | 508 |
| Water-test hole | 602 |

### DETAILED DESCRIPTION OF THE PREFERRED EMBODIMENTS

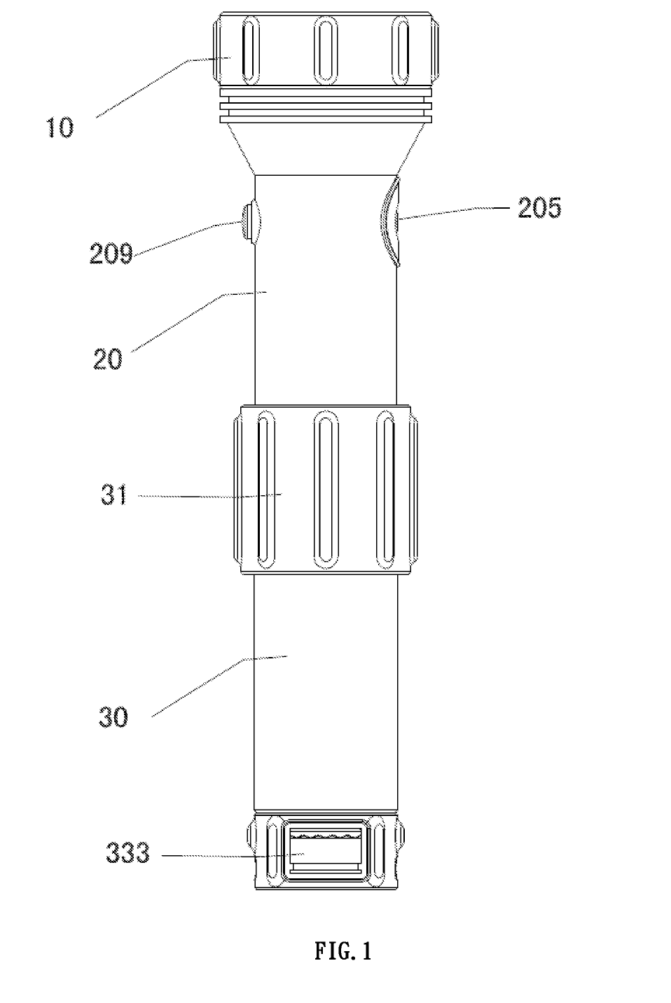

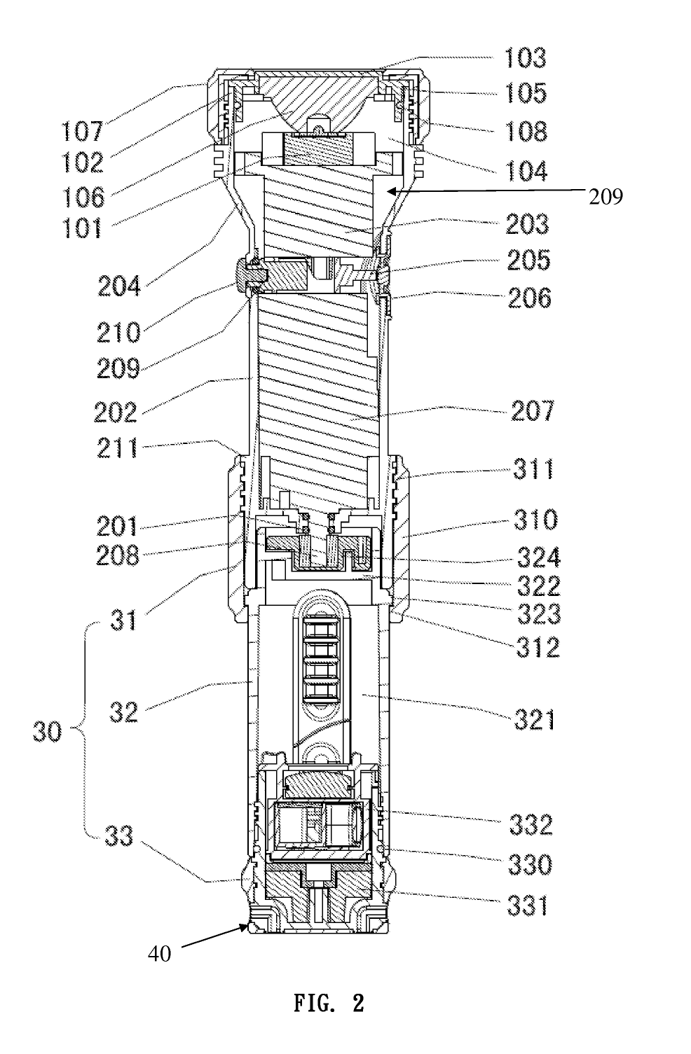

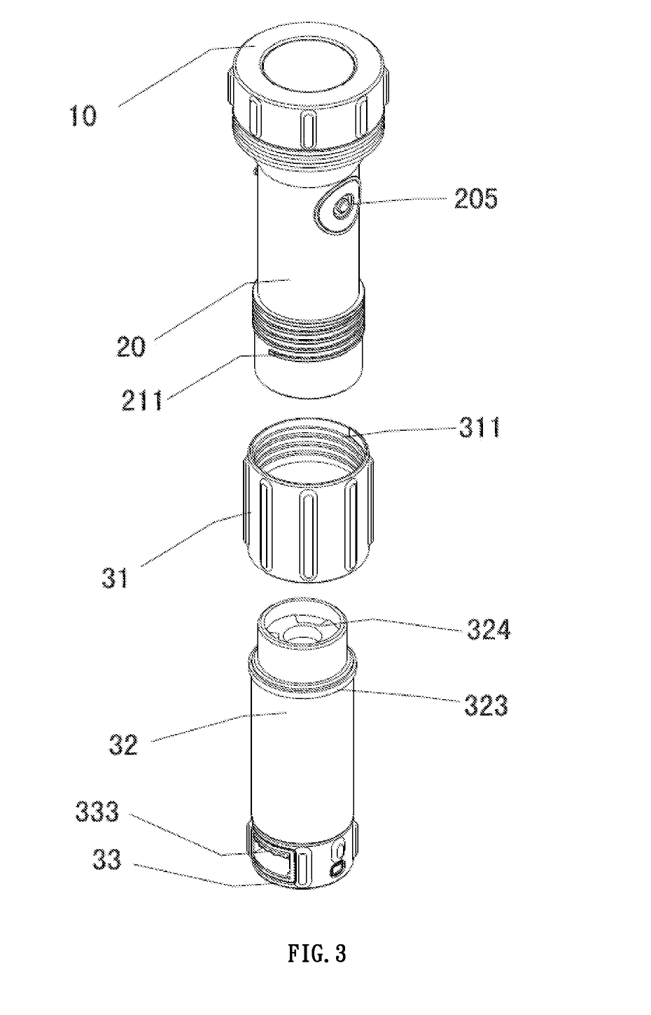

As shown in FIG. 1, FIG. 2 and FIG. 3, an apparatus for transmitting light of an embodiment of the present invention comprises a first portion 10, a second portion 20 being mounted to the said first portion 10, and a third portion 30 being mounted to the said second portion 20.

The first portion 10 comprises a light emitting member 101, a shell 102 adapted for receiving the light emitting member 101, and a light transmitting window 103 of the closed shell 102.

A light emitting diode is preferably adopted as the light emitting member 101. A lighting emitting component of other type such as an incandescent bulb may also be adopted as the light emitting member. The shell 102 is a cylindrical structure approximately and forms a first hollow floating region 104 adapted for receiving the light emitting member 101. One end of the shell 102 is open to form a window 105 for light to penetrate through. The light transmitting window 103 is received and mounted at the window 105. Usually the light transmitting window 103 is mounted to the window 105 with glue. Alternatively, a seal ring 108 is further mounted between the light transmitting window 103 and the shell 102 in order to ensure the tightness between the light transmitting window 103 and the shell 102 to achieve a certain waterproof standard. As such, water is prevented from entering into the first portion 10 to affect the work of such an electrical component, such as the light emitting member 101. Alternatively, the apparatus for transmitting light can be split for use so as to increase the flexibility.

In the embodiment, an optical component such as a lens 106 is received and mounted to the light emitting member 101, such an optical component is adapted for adjusting the light shape of the light emitting member 101. The lens 106 is mounted between the light emitting member 101 and the light transmitting window 103. Typically, the lens 106 is mounted and combined together with the light emitting member 101 with glue or through other means.

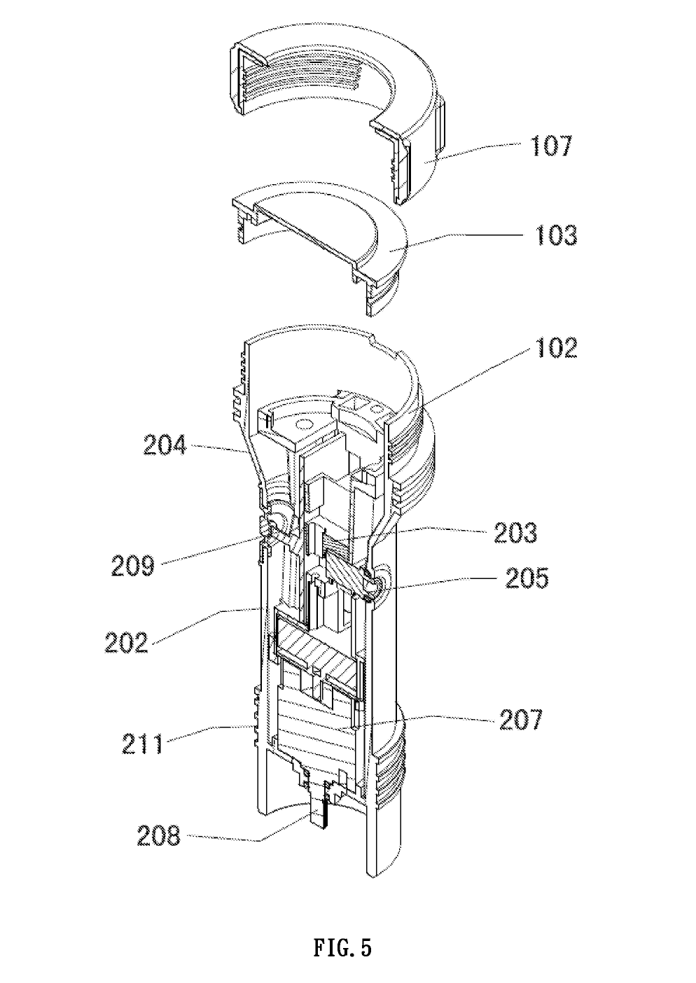

As shown in FIG. 2 and FIG. 5, a protection cover 107 for protecting the light transmitting window 103 may further be received and mounted outside the light transmitting window 103. Typically, an external thread is mounted on an outer edge of the shell 102 while an inner thread is mounted on an inner edge of the protection cover 107. Afterwards, the protection cover 107 is attached to the shell 102 through a way of threaded connection, and thus attached on the light transmitting window 103. The protection cover 107 is adapted to prevent the apparatus for transmitting light from causing adverse effects on the light transmitting window 103 due to such factors as collision in the course of use, and avoid unnecessary loosening of the light transmitting window 103 and the shell 102. Further, the second portion 20 comprises a shell 202 and such a component as a power supply 203 mounted inside the shell 202. Preferably, the shell 202 of the second portion 20 is substantially of a cylindrical structure. In the embodiment, the shell 202 of the second portion 20 and the shell 102 of the first portion 10 are integrally formed. Further, a transition section 204 is mounted between the shell 102 of the first portion 10 and the shell 202 of the second portion 20. The size of the transition section 204 decreases gradually from a direction towards the first portion 10 to a direction towards the second portion 20, thus the shell 102 of the first portion 10 has a volume larger than that of the shell 202 of the second portion 20, so that the shell 102 is adapted to mount to the shell 202 smoothly through the transition section 204.

The power supply 203 is electrically mounted to the light emitting member 101, and is adapted for providing electric energy for the light emitting member 101 to transmit light. A switch 205 controlling the power supply 203 is further mounted on the shell 202. The switch 205 is exposed out of the shell 205 through a hole (not marked) on the shell 202. An operator may hold the shell 202 by hand and control to turn on and off the light emitting member 101 through operating the switch 205. Preferably, the switch 205 is a push type switch. Alternatively, operation keys of various operation modes are provided. For example, the light emitting member 101 can be turned on to transmit light by pressing the switch 205 once; the luminance is enhanced by one grade by pressing the switch once again; the luminance is further enhanced by pressing the switch for the second time; the luminance reaches a maximum grade by pressing the switch for the third time; and the light emitting member 101 is turned off by pressing the switch for the fourth time. The light emitting member 101 is turned on and off and the luminance is adjusted by pressing the switch repeatedly.

In order to enhance the overall waterproof performance of the apparatus for transmitting light, a sealing member 206 is mounted to the hole of the shell 202 being mounted with the switch 205. The sealing member 206 seals the hole of the shell 202 so as to prevent water vapor or the like entering the shell 202.

The power supply or battery 203 can be a storage battery or other type of power supply. In the embodiment, the power supply 203 is a rechargeable power supply, so that the power supply or battery 203 may be repeatedly used, thus prolonging the whole service life of the apparatus for transmitting light. Preferably, a battery 207 is mounted inside the shell 202. Electric energy may be produced by charging the battery 207 and/or 203, and stored in the power supply 203 or 207 for use. The battery 207 or the battery charging means comprises an extending member 208 which is extended from an end of the shell 202. By rotating the extending member 208, the battery 207 or 203 will be charged and generated power and directly store the electric energy into the power supply or battery 207 or 203. The apparatus for transmitting light having the battery 207 or 203 is more suitable for outdoor lighting. For example, when the electric energy of the apparatus for transmitting light is insufficient or runs out in the course of use, the battery 207 or 203 can be mechanical charged by hand immediately, so that the apparatus for transmitting light may immediately obtain the electric energy for transmitting light again so as to meet the lighting demand of a user.

Preferably, the apparatus for transmitting light comprises a battery charging means. The battery charging means comprises an extending member 208 which is mounted to the end of the second portion 20. The extending member 208 is adapted for charging the battery by rotating. The battery charging means further comprises an extending member receiver 324 adapted for receiving the extending member 208 mounted to an end of the third portion 30. The extending member 208 comprises a polygonal cylindrical structure or other cylindrical structure. The third portion 30 is adapted to be rotated about the axis of the extending member 208.

In another embodiment, the extending member 208 is a rod. The battery 207 or 203 may generate power by rotating the rod. Preferably, the rod piece is designed to have a corner angle or other special shape, so as to be beneficial for the rotating operation of the extending member 208. In another embodiment, a corresponding structure or the extending member receiver 324 is mounted on the third portion 30, adapted for receiving the extending member 208. The battery 207 or 203 can be operated by rotating the third portion 30. The specific structure of the third portion 30 will be further described hereinafter.

Alternatively, the apparatus for transmitting light comprises a battery charging means so that the battery is charged through rotating motion of the third portion 30.

In the embodiment, a plurality of seal rings 201 are mounted to a portion of the extending member 208 in the shell 202 in order to seal a gap between the extending member 208 and the shell 202 so as to prevent water vapor entering into the shell 202.

Alternatively, the apparatus for transmitting light further comprises a discharging interface 209 adapted for charging electronic products carried by a user such as a media player like MP3 or a portable electronic communication device such as a mobile phone. As shown in FIG. 2, the discharging interface 209 is mounted on the shell 202. The discharging interface 209 and the switch 205 are mounted in opposing positions of the shell 202. The discharging interface 209 is electrically mounted to the power supply 203 or 207 in the shell 202. The electronic product is connected with the discharging interface 209 through a relevant cable, so that the power supply 203 can be used as an external power supply of the electronic product to power the electronic product.

In order to ensure the waterproof requirement of the discharging interface 209, a sealing member 210 will be mounted to the discharging interface 209. When the discharging interface 209 is idle, the sealing member 210 is sealed in the discharging interface 209 to prevent water vapor from entering the shell 202 to affect the working of the electric component in the shell 202.

Alternatively, the third portion 30 comprises a handle 31, a third portion 32 and a bottom cover 33. The end of the third portion 30 mounted to the second portion 20 is adapted for prolonging the length of the second portion 20 so as to hold the apparatus for transmitting light more conveniently. Meanwhile and more importantly, the third portion 30 also has other technical features. Such features will be described in details hereinafter.

Preferably, the apparatus for transmitting light comprises a floating means comprising a weight member 331 being mounted to an end portion of the apparatus for transmitting light adapted for providing downward force to the apparatus. The weight member 331 enables the first portion 10 of the apparatus for transmitting light to be floated above the water level. While a portion of the apparatus for transmitting light can be vertically mounted below the water level. As such, the apparatus for transmitting light can send out a flashlight “SOS” signal above the water level. Preferably, the weight member is mounted in the fourth portion 40. Further, the floating means comprises a hollow floating region adapted for providing upward force to the apparatus arranged inside the said apparatus. The hollow floating region comprises a first hollow floating region 104 being arranged between an inner wall of the first portion 10 and the light emitting member 101, a second hollow floating region 109 being formed between an inner wall of the second portion 20 and an outer wall of the battery 207, and a third hollow floating region 321 being formed between the opposing inner walls of the said third portion 30.

The third portion 32 has a hollow structure and forms the third hollow floating region 321. One end of the third portion 32 is mounted together with the shell 202 of the second portion 20 through the handle 31, and the other end of the third portion 32 is mounted to the bottom cover 33, thus the second portion 20 and the bottom cover 33 are respectively sealed at the two ends of the third portion 32, so that the third hollow floating region 321 in the third portion 32 forms a closed space. The third hollow floating region 321 having a certain size and being closed can provide a certain buoyancy, so that the apparatus for transmitting light can be still floated above the water level rather than sunk to the water bottom due to the generated by the third hollow floating region 321 when the apparatus falls into the water due to accident during outdoor use. Therefore, the safety of the apparatus for transmitting light is higher.

In the embodiment, the first hollow floating region 104 is formed inside the said first portion 10, excellent waterproof status of the first hollow floating region 104 can be kept through installation of the component such as the seal ring 108 since relevant part such as the light emitting member 101 does not fully fill inside the first hollow floating region 104, and thus enabling the first hollow floating region 104 to further have a capacity of providing a certain buoyancy or floating force. As an assistance of the third hollow floating region 321 in the third portion 32, the setting of the first hollow floating region 104 in the first portion 10 enables the apparatus for transmitting light to have a larger buoyancy or floating force when falling into the water, guarantees the apparatus for transmitting light to be floated above the water level sufficiently, and prevents the apparatus for transmitting light from an accident of sinking into the water bottom during outdoor application.

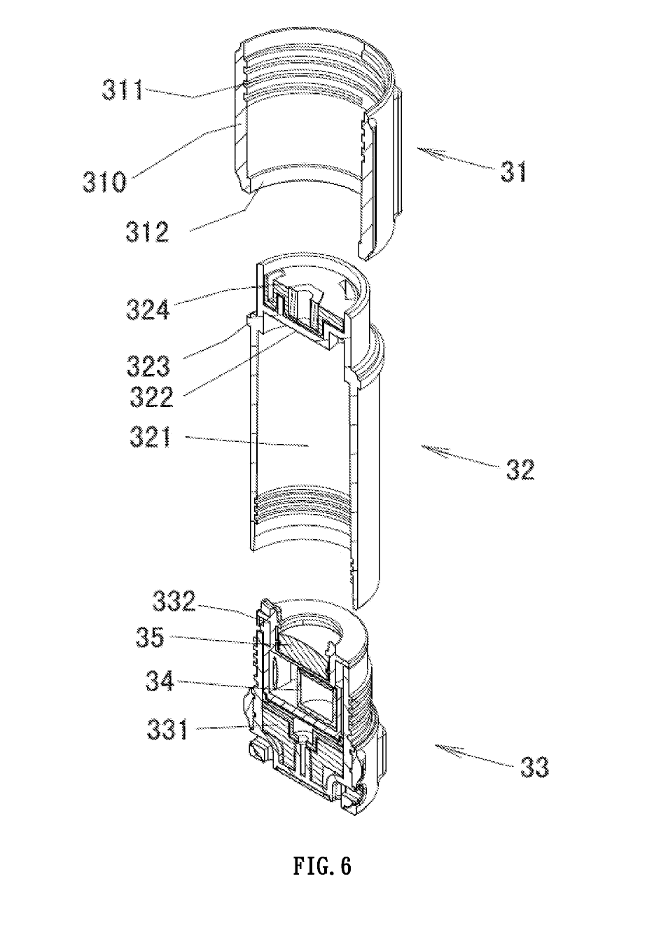

FIG. 2, FIG. 3 and FIG. 6 show a structure of the handle 31. The handle 31 comprises a body 310 as well as a first connecting part 311 and a second connecting part 312 respectively mounted at the two ends of the body 310. The body 310 comprises a substantially cylindrical structure. The first connecting part 311 is adapted for mounting with the shell 202 of the second portion 20. Therefore, a connecting part 211 of the first connecting part 311 is also formed on a corresponding portion of the shell 202. The first connecting part 311 and the shell 202 can be connected by ways of clamping, blocking or threaded connection. In the embodiment of the above figures, the threaded connection is applied such that the first connecting part 311 is an inner thread mounted on an inner wall of the body 310 while the connecting part 211 of the shell 202 is an outer thread mounted to a corresponding portion of the shell 202.

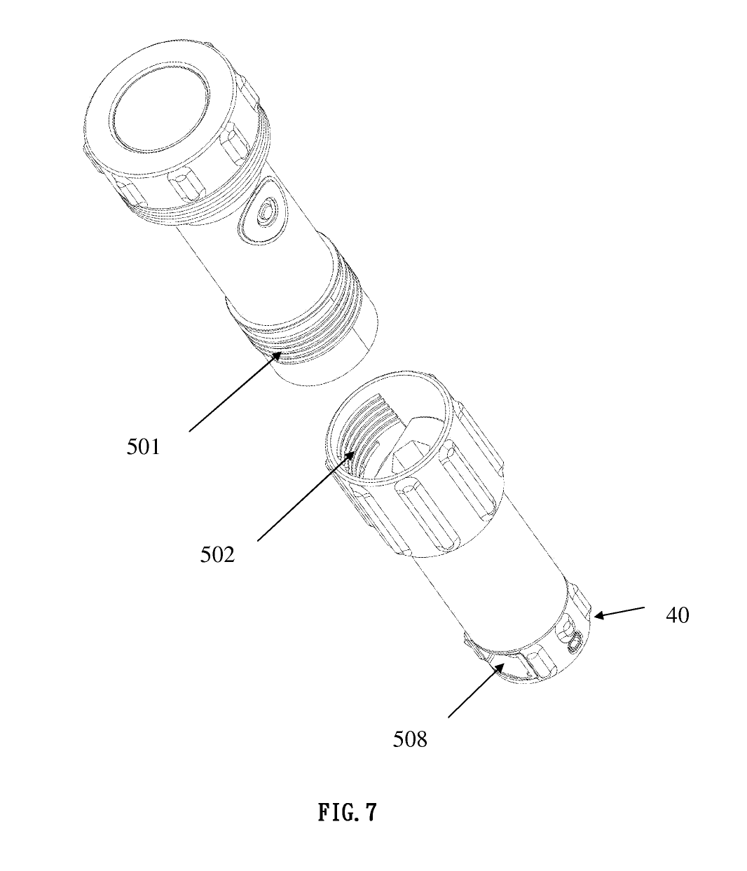

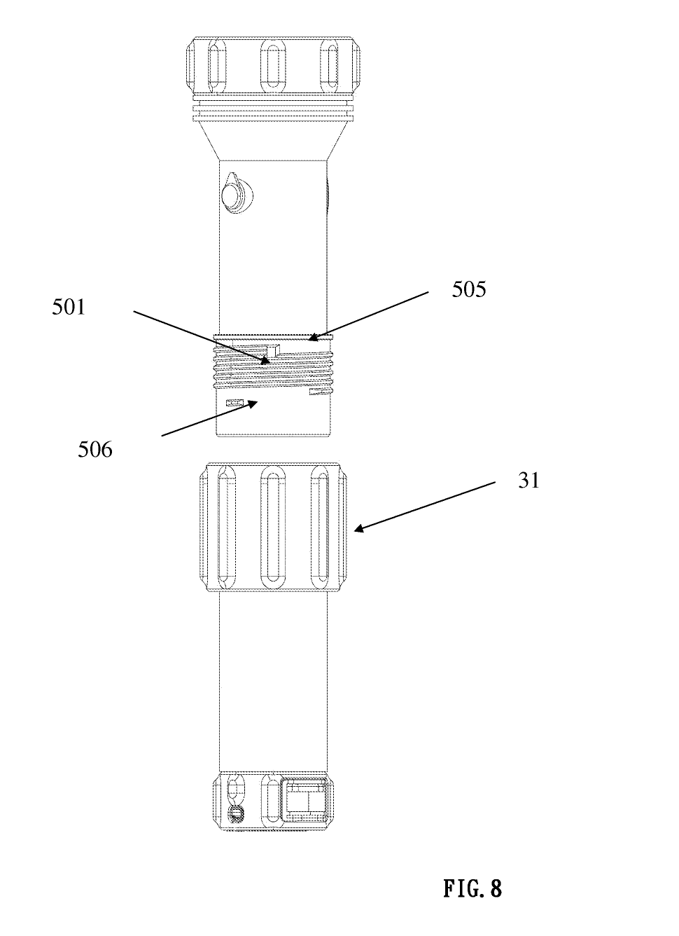

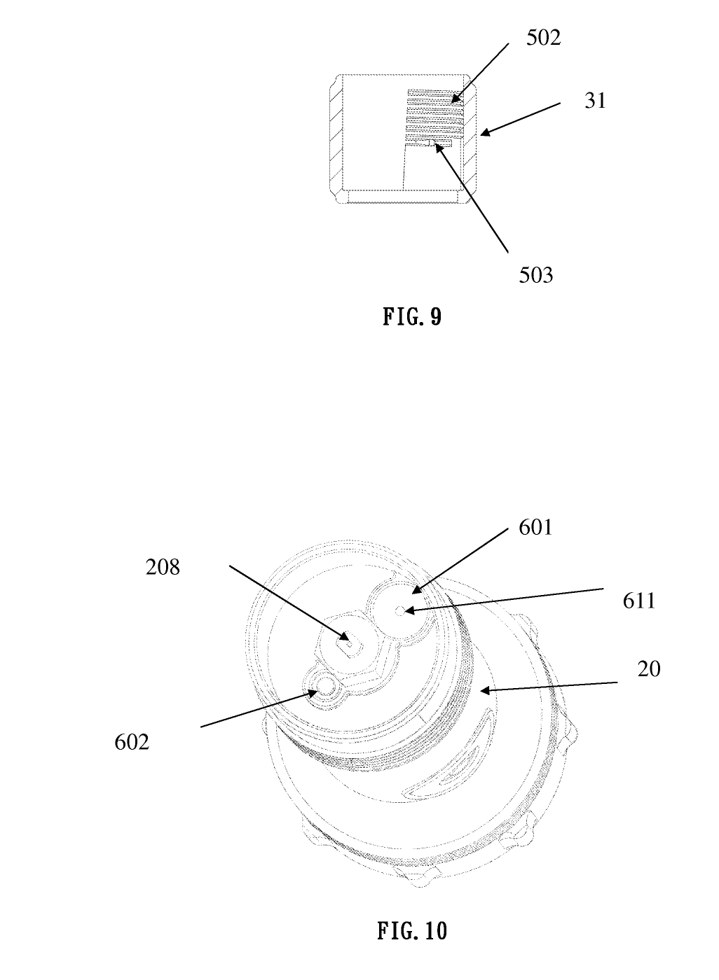

As shown in FIG. 7, FIG. 8 and FIG. 9, the apparatus for transmitting light comprises a handle means adapted for mounting the third portion 30 to the second portion 20 and preventing the third portion 30 being removed from the second portion 20 during the movement of rotating the third portion 30. The handle means comprises the handle 31, a threaded portion 501 of the second portion 20 and a first thread locking structure 505 being mounted to the threaded portion. The first thread locking structure 505 is adapted for mounting an end of a thread line of a threaded portion 502 of an inner wall of the handle. The handle means further comprises a second thread locking structure 506 mounted on a surface of an end portion of the second portion 20. The second thread locking structure 506 is adapted for mounting the second thread locking structure 506 to an extension 503 which is mounted on the threaded portion of the inner wall of the handle. Further, the height of the first locking structure 505 is higher than the height of the thread portion 501 of the second portion. The first locking structure 505 is mounted between at least two thread lines of the thread portion 501.

Alternatively, one end of the third portion 32 mounted to the second portion 20 comprises a bottom board 322 adapted for sealing the corresponding end of the third portion 32. Therefore, the third portion 32 is sealed without relying on the shell 202 of the second portion 20. The bottom board 322 can be integrally formed with the third portion 32 which is able to restrict water entering into the end of the third portion 32, thereby sufficiently reflecting the capacity of the third hollow floating region 321 for generating the buoyancy or floating force.

The second connecting part 312 is mounted to the third portion 32. In the embodiment, the third portion 32 is integrally formed with the handle 31. That is, the corresponding end of the third portion 32 extends to form the said handle 31 and forms corresponding connection with the second portion 20.

In the embodiment, the third portion 32 is removably mounted to the second connecting part 312 of the handle 31. The corresponding end of the third portion 32 forms a connecting part 323 for receiving the second connecting part 312. In the embodiment, as shown in FIG. 2, the connecting 323 is a flange formed by extending the edge of the bottom board 322 externally. The second connecting part 312 is a flange formed by extending the inner wall of the body 310 internally. The connecting and the second connecting part are mutually clamped, so that the third portion 32 can rotate freely after the third portion 32 is mounted to the second portion 20 through the handle 31. Further, the apparatus for transmitting light comprises the second portion 20 removably mounted to the first portion 10, the third portion 30 removably mounted to the second portion 20, and the fourth portion 40 removably mounted to the third portion 30. The battery is mounted in the second portion 20.

Further, the extending member receiver 324 adapted for receiving the extending member 208 mounted to the second portion 20 is formed in the third portion 32. The extending member receiver 324 can be a part having a concave structure formed on the bottom board 322. The concave structure is adapted for receiving the extending member 208 of the battery 207 or 203. When rotating the third portion 32, the extending member 208 can be rotated, thus starting the battery 207 to generate power. In the embodiment, the third portion 32 become one of the battery charging module of the battery 207 or 203 so as to charge the battery 207 or 203 conveniently. The invention solves the technical problem of the torch of the existing technology that a user needs to apply a larger force to rotate a charging module to charge since an axis of the charging module is too long.

Meanwhile, the third hollow floating region 321 of the third portion 32 can be served as a storage region for storing an article such as a cable mounting the electronic product to the discharging interface 209 on the shell 202. The cable can be arranged in the third hollow floating region 321 when being not used, and can be taken out from the third hollow floating region 321 when being used so as to mount the electronic product to the discharging interface 209. The third hollow floating region 321 is further adapted for storing other small appliances required during outdoor activities, such as compass, whistle, bottle opener, knife. Further, as shown in FIG. 7, FIG. 8 and FIG. 9, an outer side wall of the fourth portion 40 has a hole forming a bottle opener 508. The third portion 30 forms a storage region adapted for receiving at least one article inside the third portion 30. The second portion 20 comprises an external charging member adapted for providing electricity from the battery 207 to an article.

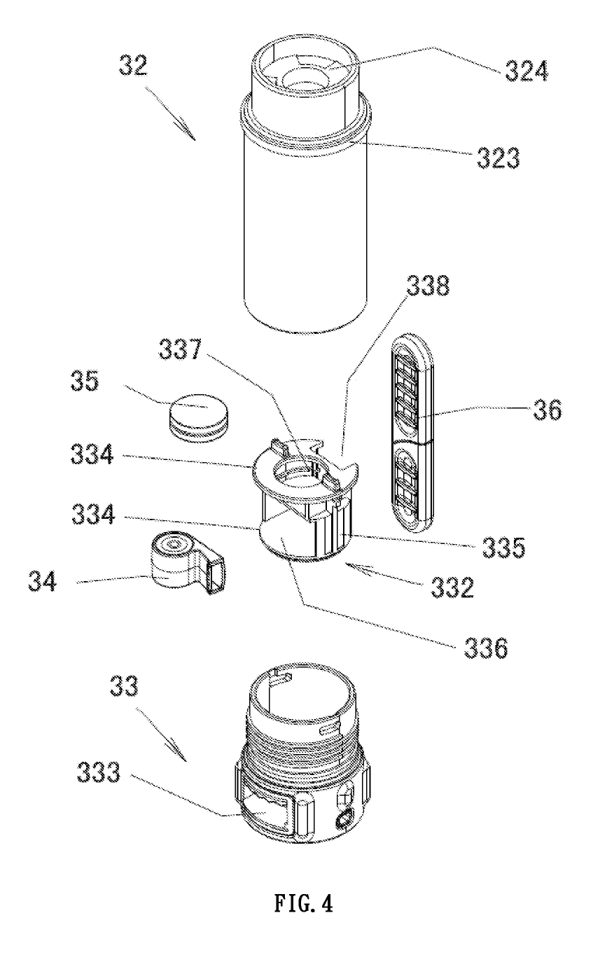

As shown in FIG. 2, FIG. 3 and FIG. 4, the bottom cover 33 and the third portion 32 are sealingly mounted with each other. A corresponding seal ring 330 is arranged at the connected portion. As shown in the FIGs, the third portion 32 and the bottom cover 33 are mounted together in form of threaded connection. Alternatively, other connection ways capable of realizing better sealing effects are also feasible.

In the embodiment, a weight member 331 is mounted inside the bottom cover or the fourth portion 33. The density of the weight member 331 is obviously larger than the density of the bottom cover or the fourth portion 33 and the density of the second portion 20. For example, the bottom cover or the fourth portion 33 is usually manufactured by plastic. Then the weight member 331 can be manufactured by such metals like steel and iron. By setting the weight member 331, the center of gravity of the apparatus for transmitting light may shift to one end of the bottom cover or the fourth portion 33. Such setting can enable the bottom cover or the fourth portion 33 to face downwards when the apparatus for transmitting light falls into water, so that the first portion 10 faces above the water level; therefore, the light sent out by the first portion 10 is easy to transmit through the water level. As such, when an accident occurs, for example, the apparatus for transmitting light falls into the water carelessly when the apparatus for transmitting light is used in a dark environment, the apparatus for transmitting light can be positioned more easily, thus providing convenience for taking makeup measures.

A hole 333 is further mounted on the bottom cover 33. A hard material such as a metal sheet can be received and mounted in the hole 333, so that the hole 333 is adapted for opening a bottle cover such as a bottle cover of drinks. In this way, the bottom cover or the fourth portion 33 can be used as a bottle opener, so that multiple functions are provided.

Further, a commodity shelf 332 is received and mounted inside the bottom cover or the fourth portion 33. The commodity shelf 332 and the bottom cover or the fourth portion 33 can be mounted and fixed through a clamping way.

Referring to the implementation of the embodiment relating to commodity shelf 332 of the present invention, some appliances possibly used outdoors can be integrated and attached to the commodity shelf 332. Moreover, the appliances can be received in the third hollow floating region 321 of the third portion 32 through the combination of the bottom cover 33 and the third portion 32.

As shown in FIG. 4 and FIG. 6, the commodity shelf 332 comprises two parallel board bodies 334 and a support 335 connecting the board bodies 334. A first storage region 336 is arranged between the two board bodies 334. A second storage region 337 is formed on a hole of one board body 334. A third storage region 338 is formed on a gap arranged on the support 335. The first storage region 336 is adapted for storing a whistle 34. The second storage region 337 is adapted for storing a compass 35. The third storage region 338 is adapted for storing a knife 36. Such setting enables the apparatus for transmitting light to have a storage function so as to be capable of meeting multiple demands of outdoor activities.

As shown in FIG. 10, in order to prevent over-large or less pressure inside the apparatus for transmitting light to affect operation and prevent water from entering the apparatus for transmitting light, the apparatus for transmitting light, preferably, comprises a pressure balancing film 601 mounted on an end of the second portion facing an end of the third portion 30. The pressure balancing film 601 comprises a plurality of holes 611 adapted for allowing air to pass through the hole 611 only. Further, a water-test hole 602 is used for testing the waterproof condition of the apparatus for transmitting light. In general, the water-test hole 602 is closed.

The present invention has been described in detail, with reference to the preferred embodiment, in order to enable the reader to practice the invention without undue experimentation. However, a person having ordinary skill in the art will readily recognize that many of the previous disclosures may be varied or modified somewhat without departing from the spirit and scope of the invention. Accordingly, the intellectual property rights to this invention are defined only by the following claims.

1. An apparatus for transmitting light comprising:
a first portion adapted for receiving the light emitting member;
a battery being mounted inside the said apparatus; and
a floating means for allowing a portion of the apparatus to be floated above the water level comprising a weight member being mounted to an end portion of the said apparatus adapted for providing downward force to the apparatus and a hollow floating region adapted for providing upward force to the apparatus arranged inside the said apparatus.

2. The apparatus according to claim 1, wherein the said apparatus further comprises a second portion being removably mounted to the said first portion, a third portion being removably mounted to the said second portion and a fourth portion being removably mounted to the said third portion, a battery is mounted inside the said second portion.

3. The apparatus according to claim 2, wherein the said hollow floating region comprises a first hollow floating region being arranged between an inner wall and the said light emitting member, a second hollow floating region being formed between an inner wall of the said second portion and an outer wall of the said battery and a third hollow floating region being formed between the opposing inner walls of the said third portion.

4. The apparatus according to claim 2, wherein the apparatus further comprises a battery charging means for charging the said battery through rotating motion of the said third portion of the apparatus.

5. The apparatus according to claim 4, wherein the battery charging means comprises an extending member which is mounted to an end of the said second portion, the said extending member is adapted for charging the said battery by rotating the said extending member, the said battery charging means further comprises an extending member receiver adapted for receiving the said extending member mounted to an end of the said third portion,

6. The apparatus according to claim 5, wherein the said extending member comprises a polygonal cylindrical structure.

7. The apparatus according to claim 2, wherein the said weight member is mounted inside the said fourth portion.

8. The apparatus according to claim 2, wherein the apparatus further comprises a handle means for mounting the said third portion to the said second portion and preventing the said third portion being removed from the said second portion during the movement of rotating the said third portion.

9. The apparatus according to claim 8, wherein the said handle means comprises a handle, a threaded portion of the said second portion and a first thread locking structure being mounted to the said threaded portion, the said first thread locking structure is adapted for mounting an end of a thread line of a threaded portion of an inner wall of the said handle.

10. The apparatus according to claim 9, wherein the said handle means further comprises a second thread locking structure mounted on a surface of an end portion of the said second portion, the said second thread locking structure is adapted for mounting the said second thread locking structure to an extension which is mounted on the said threaded portion of the inner wall of the said handle.

11. The apparatus according to claim 2, wherein the apparatus further comprises a pressure balancing film mounted on an end of the said second portion facing an end of said third portion, the said pressure balancing film comprises a plurality of holes adapted for allowing air to pass through the said hole only.

12. The apparatus according to claim 5, wherein the said third portion is adapted to be rotated about the axis of the said extending member.

13. The apparatus according to claim 2, wherein the said third portion is removably mounted to the said fourth portion, an outer side wall of the said fourth portion has a hole forming a bottle opener, the said third portion forms a storage region adapted for receiving at least one article inside the said third portion, the said second portion comprises an external charging member adapted for providing electricity from the said battery to an article.

14. The apparatus according to claim 9, wherein the height of the said first locking structure is higher than the height of the said thread portion of the said second portion, the said first locking structure is mounted between at least two thread lines of the said thread portion.
